(19) United States
(12) Patent Application Publication
(10) Pub. No.: US 2010/0061732 A1
(43) Pub. Date: Mar. 11, 2010

(54) SMALL FORM FACTOR PLUGGABLE TRANSCEIVER MODULE

(75) Inventor: Renaud Lavoie, Laval (CA)

Correspondence Address: BCF LLP, 1100 RENE'-LE'VESQUE BLVD. WEST, 25TH FLOOR, MONTREAL, QC, H3B-5C9, CA

(73) Assignee: EMBRIONIX DESIGN INC., Laval (CA)

(21) Appl. No.: 12/552,000

(22) Filed: Sep. 1, 2009

Related U.S. Application Data
(60) Provisional application No. 61/094,434, filed on Sep. 5, 2008.

(51) Int. Cl. H04B 10/00

(52) U.S. Cl. 398/115

(57) ABSTRACT

The present invention relates to small form factor pluggable (SFP) transceiver modules. The SFP transceiver module of the present invention comprises a cage corresponding to SFP dimensions, at least one coaxial connector for receiving and/or transmitting an electrical signal, at least one processing unit for processing a received signal, and a host connector for receiving and/or transmitting a processed signal.

### FIELD OF THE INVENTION

The present invention relates to connection modules, and more particularly to a Small Form Factor Pluggable transceiver module.

### BACKGROUND OF THE INVENTION

The industry related to video has greatly evolved in the past years. With higher definitions, the requirements for transporting video are more demanding than ever before. These new requirements thus create a need for components capable of reliably and cost-effectively transport video. One such component is connectors, also called transceivers, that allow interconnection with either coaxial cable or optic fiber and electronic equipment. More specifically, in broadcasting facilities, the connectors need to act as a Serial Digital Interface (SDI) capable of supporting digital video of various formats: standard definition, High Definition, 1080 p at 2.97 Gbps or 2.97/1.001 Gbps, etc.

In addition to the various formats to be supported for digital video, there are various applications where the digital video must be received through a first medium, and redirected through an alternative medium, i.e. from coaxial cable to optical fiber.

There is therefore a need for a new type of transceiver module that is adapted to video needs.

### SUMMARY OF THE INVENTION

The present invention relates to a small form factor pluggable (SFP) transceiver module. The module comprises a cage, at least one coaxial input, at least one processing unit, and a host connector. The cage corresponds to SFP standardized dimensions, such as for example the Small Form-factor Pluggable Transceiver MultiSource Agreement. The at least one coaxial input is adapted for receiving a signal. The at least one processing unit is in turn adapted for processing the received signal, while the host connector is suited for outputting the processed signal.

In accordance with another aspect of the present invention, there is provided a small form factor pluggable (SFP) transceiver module in which the host connector is adapted to receive a signal, while the at least one coaxial output is adapted to transmit the processed signal.

### BRIEF DESCRIPTION OF THE DRAWINGS

The present invention will be further described with reference to the following figures, in which similar references denote similar parts:

FIG. 1 is a schematic representation of a room to room utilization of the present invention;

FIG. 2 is a schematic representation of a floor-to floor utilization of the present invention;

FIG. 3 is a schematic representation of a building to building utilization of the present invention;

FIG. 4 is a schematic representation of an expandable equipment in which the present invention can be used;

FIG. 5A-5E are schematic representations of transceiver modules having a receiving coaxial connector in accordance with aspects of the present invention;

FIG. 6 is a schematic representation of a transceiver module including a receiving and a transmitting coaxial connectors in accordance with another aspect of the present invention;

FIGS. 7A-7B are schematic representations of a transceiver module including one or several transmitting coaxial connectors in accordance with yet another aspect of the present invention; and

FIG. 8 is an exemplary schematic representation of an inside structure of a transceiver module in accordance with an aspect of the present invention.

### DETAILED DESCRIPTION OF THE INVENTION

The present invention relates to the field of SPF transceiver modules. Requirements for SPF transceivers are defined in the Small Form-factor Pluggable Transceiver MultiSource Agreement (MSA) signed on Sep. 14, 2000 by various manufacturers. However, this agreement only relates to fiber optic applications. Video transmission is not limited to fiber optic applications, and still today, many applications rely on coaxial cable.

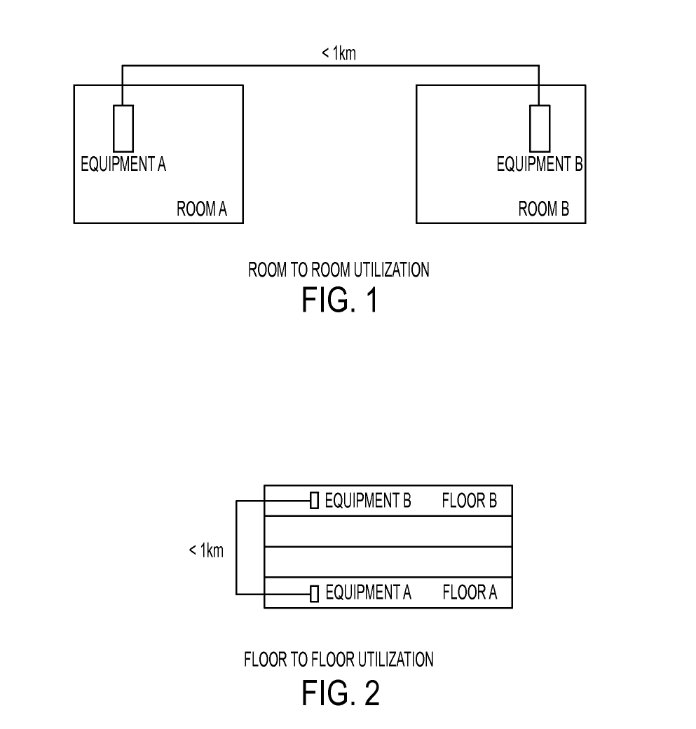

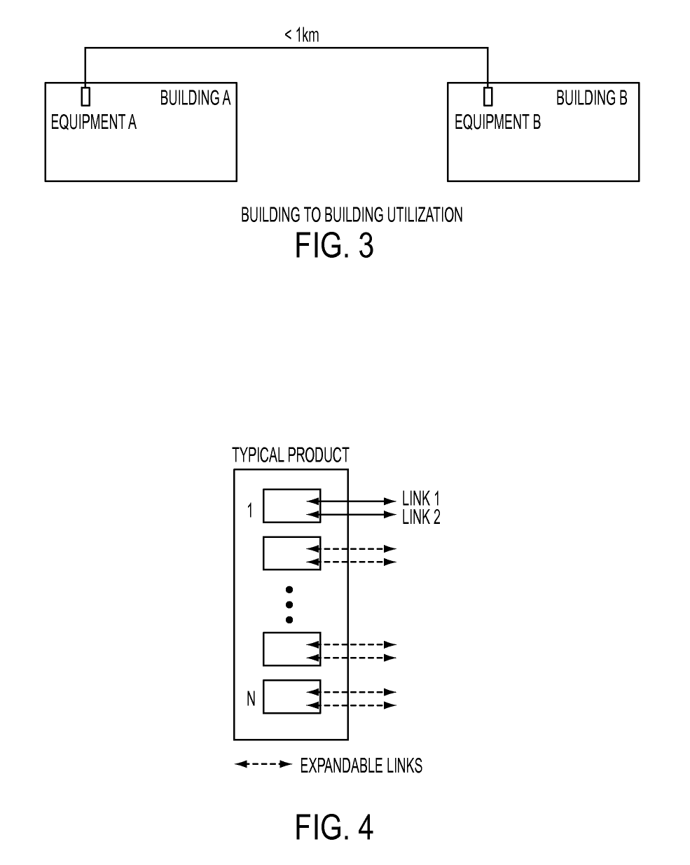

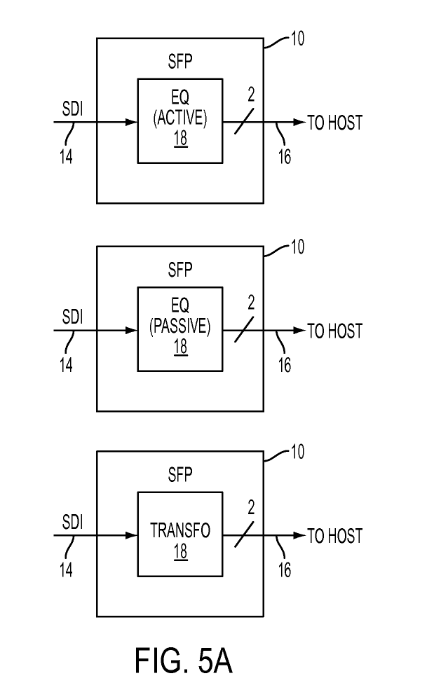

Exemplary applications, which rely on coaxial cable in which the present invention is used, are depicted on FIGS. 1 to 3. Such applications include transmission of video signals on coaxial cable between two rooms of an office, transmission of video signals on coaxial cable between two floors of a building, and transmission of video signals on coaxial cable between two buildings.

Typically, in broadcast facilities, Serial Digital Interfaces (SDI) are used for transporting digital video uncompressed, of different possible formats: standard definition, high definition, 1080 pixls format at 2.97 Gbps, etc. SDI is standardized by the Society of Motion Picture and Television Engineers (SMPTE). Examples of standards include SMPTE 274M-2005 (Image Sample Structure, Digital Representation and Digital Timing Reference Sequences for Multiple Picture Rates), SMPTE 292M-1998 (Bit-Serial Digital Interface for High Definition Television), SMPTE 291M-1998 (Ancillary Data Packet and Space Formatting), SMPTE 372M-2002 (Dual Link 292M Interface for 1920×1080 Picture Raster), SMPTE 424M (3 Gbps Serial Digital Interface), SMPTE-259M (Television—SDTV Digital Signal/Data—Serial Digital Interface), SMPTE-310M (Television—Synchronous Serial Interface for MPEG-2 Digital Transport Systems), SMPTE-344M (Television—540 Mb/s Serial Digital Interface) and SMPTE-425 (Television—3 Gb/s Signal/Data Serial Interface—Source Image Format Mapping).

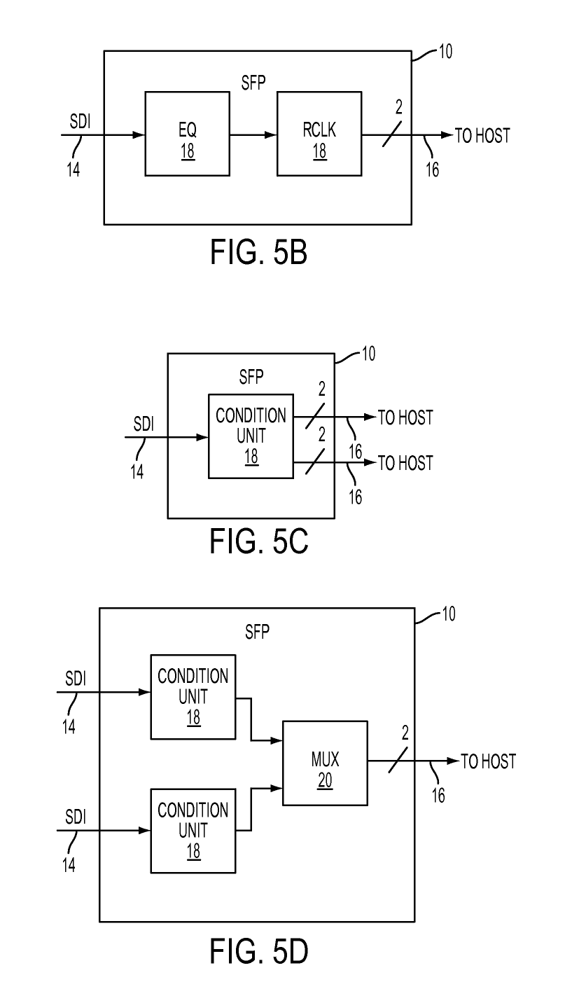

In order to alleviate the problems encountered today, the present invention proposes a new SFP transceiver module that includes at least one coaxial input and/or output. The transceiver module of the present invention is thus adapted to be a direct replacement for fiber SFP module dedicated for SDI transport for shorter distances, such as for example distances less than 1 km. As with regular SFP modules, the SFP transceiver module of the present invention is adapted to be used with expandable equipment such as shown on FIG. 4, and is preferably hot pluggable, i.e. the transceiver module can be connected to a product while the product is in function. As like all other SFPs transceiver modules, the SFP transceiver module of the present invention is rather compact, which brings a better density on the hosting product to which it is connected.

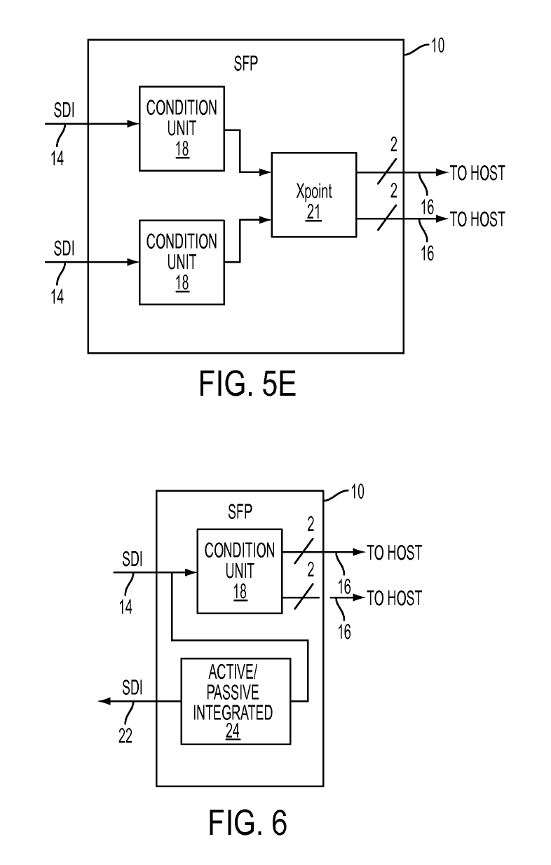

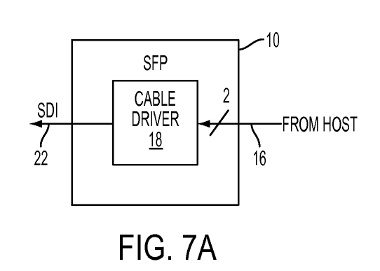

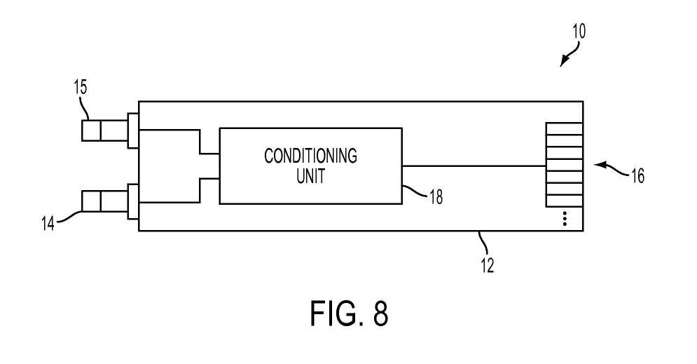

Reference is now concurrently made to FIG. 8, which depicts a schematic representation of an internal structure of the SFP transceiver module 10 of the present invention, and FIGS. 5-7, which depict various possible embodiments of the present invention. The transceiver module 10 is embedded within a cage 12 that corresponds to agreed SFP dimensions. The SFP transceiver module 10 is provided with one or several coaxial input(s) 14 and a host connector 16, either MSA or non-MSA, such as for example a 20-pin connector.

The industry currently supports various types of coaxial connectors, and each connector. Examples of coaxial connectors that can be received by the coaxial input of the present invention include: BNC connectors, DIN 1.0/2.3 connectors, SubMiniature version A (SMA) connectors, SubMiniature version B (SMB) connectors, SMP connectors, micro coaxial connectors, micro-miniature coaxial connectors, or any adaptor ending with a coaxial interface. Thus, the coaxial input(s) 14 of the present invention could consist of any one of the previously mentioned connectors or their corresponding input. Furthermore, the coaxial input(s) 14 further include(s) either single or multiple coaxial connectors, male or female, with any type of mounting (Edgemont, straight, right angle, etc.).

The SFP transceiver module 10 may further be provided with an optical connector 15. The one or several coaxial input(s) 14, the host connector 16 and the optical connector 15 are adapted for receiving and/or transmitting signal. The signal that is received by either the coaxial input 14, the optical connector 15 or the host connector 16 are then provided to a processing unit 18. The processing unit 18 is adapted to perform multiple various tasks:
convert received electrical signal in an optical signal, or convert received optical signal into an electrical signal;
separating or combining digital and analog video signals received;
calculate from received multiple signals differential outputting signals;
receive differential input signals and create multiple coaxial outputs there form;
reshape and/or recondition received signal so as to improve jitter or any other quality parameter of the received signal;
etc.

Thus the SFP transceiver module 10 may act as a passive or an active serial digital interface.

Exemplary variants of the SFP transceiver module 10 of the present invention are shown on FIGS. 5A-E, where the coaxial input 14 is receiving a video signal. More particularly, in FIG. 5A, three variants of the SFP transceiver module 10 are depicted. The uppermost SFP transceiver module 10 is active, as it receives the video signal through the SDI (coaxial input 14), and equalizes the received signal prior to forwarding it to the host connector 16. The center SFP transceiver module 10 is a passive module, which performs a passive equalization by means of passive electronic components. The lower SFP transceiver module 10 depicts a received video signal that is transformed, either actively or passively, prior to being forwarded to the host connector 16. FIG. 5B in turn represents an SFP transceiver module 10 in which the coaxial input 14 is receiving an entry signal that is passed along to the processing unit 18, which in this particular aspect, performs the dual functions of equalizing either actively or passively the entry signal and re-clocking the entry signal, prior to forwarding it to the host connector 16. FIG. 5C shows another variant of the present SFP transceiver module 10 in which the signal received by the coaxial input 14 is treated by the processing unit 18, and then forwarded to two host connectors 16. FIG. 5D represents yet another variant of the present SFP transceiver module 10, in which two coaxial inputs 14 receive signals, each received signal is treated by a different processing unit 18, prior to be combined by a multiplexer 20 and forwarded to the host connector 16. Turning now to FIG. 5E, the represented SFP transceiver module 10 is similar to the SFP transceiver module 10 of FIG. 5D, with the differences that the multiplexer 20 is replaced by an Xpoint 21 (also known in the art as a non-blocking routing unit), prior to being forwarded to two host connectors 16.

Reference is now made to a particular variant of the present SFP transceiver module 10, in which one coaxial input 14 and one coaxial output 22 are present. In this variant, a signal is received by the coaxial input 14. The received signal is then forwarded concurrently to the processing unit 18 and to an active/passive/ integrated loop 24. The signal received by the active/passive/integrated unit loop is copied, and then forwarded to the coaxial output 22. The signal is also concurrently processed by the processing unit 18, prior to being forwarded to one or several host connectors 16.

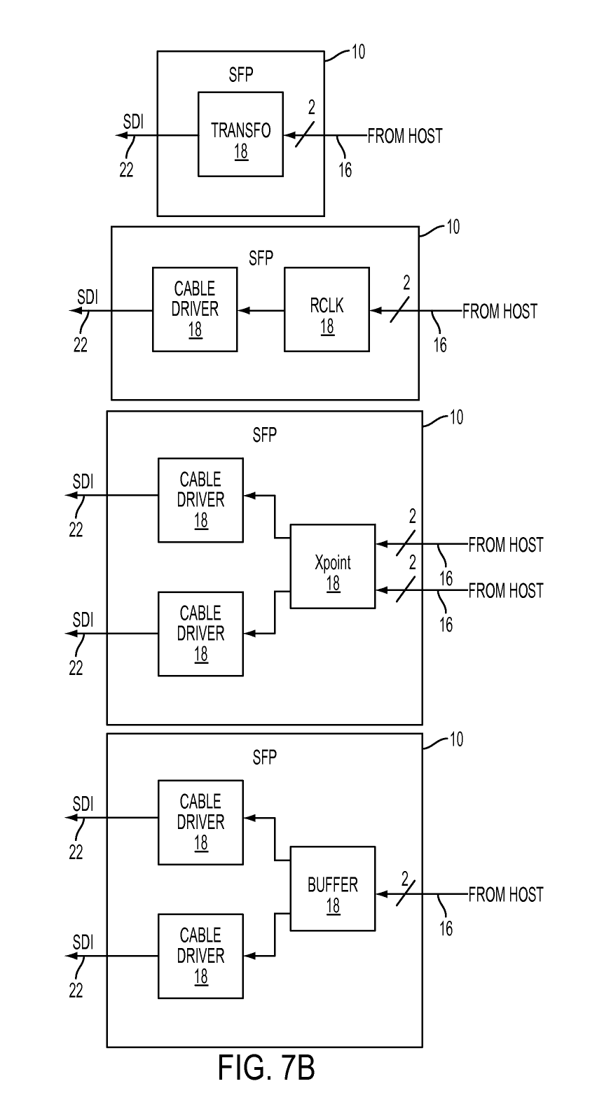

Turning now to FIGS. 7A and 7B, the depicted SFP transceiver modules 10 all have in common that they receive a signal from the host connector 16, and output a treated signal by one or several coaxial outputs 22. Similar variants of processing unit 18 to FIGS. 5A-5E are depicted.

Thus the processing unit 18 of the present invention may be an active or passive unit that is adapted for processing a signal. Furthermore, it may perform single or multiple functions concurrently or sequentially. Examples of functions that may be performed by the processing unit 18 include: equalizing, signal transformation, re-clocking, driving, signal reshaping, signal reconditioning and signal transforming, etc.

Although the present invention has been described by way of preferred embodiments, the SFP transceiver module of the present invention is not limited to the embodiments provided herein. The scope of protection sought for the SFP transceiver module should be interpreted in view of the appended claims.

1. A small form factor pluggable (SFP) transceiver module comprising:
a cage corresponding to SFP dimensions;
at least one coaxial input for receiving a signal;
at least one processing unit for processing the received signal; and
a host connector for outputting the processed signal.

2. The module of claim 1, further comprising:
an optical input for receiving another signal; and
wherein the signal processing unit is further adapted to process the other received signal.

3. A small form factor pluggable (SFP) transceiver module comprising:
a cage corresponding to SFP dimensions;
a host connector for receiving a signal;
at least one processing unit for processing the signal; and
at least one coaxial output for transmitting a processed signal.

4. The module of claim 3, wherein the signal processing unit is further adapted to process another received signal, and the module further comprises an optical output for transmitting the another signal.

5. The module of claim 3, wherein the processing unit is adapted to reshape, recondition and transform the received signal.
